(19) United States
(12) Patent Application Publication
(10) Pub. No.: US 2005/0143143 A1
(43) Pub. Date: Jun. 30, 2005

(54) Device, system and method of universal-mode communication with power saving

(76) Inventors: Erez Schwartz, Kfar Saba (IL); Yoav Volloch, Kfar Saba (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/747,218

(22) Filed: Dec. 30, 2003

(51) Int. Cl. H04M 1/00

(52) U.S. Cl. 455/574

(57) ABSTRACT

Devices, systems, and methods are provided to enable power saving when operating a communication device in an idle state in a Universal Mobile Telecommunications System. In some embodiments a method is provided to enable universal mode communication devices operating in a Universal Mobile Telecommunications System to determine whether a serving base station transmits signals using a selected Radio Access Technology (RAT) during an idle state of operation. In the case where the serving base station transmits signals using a non-selected RAT, the communication device may select a neighboring base station where an adequate signal is provided using the selected RAT, irrespective of the signal strength in the cell being served.

### BACKGROUND OF THE INVENTION

Universal Mobile Telecommunications System (UMTS) is a third generation (3G) of cellular mobile communications system that provides an enhanced range of multimedia services. The specifications defining UMTS are formulated by the 3rd Generation Partnership Project (3GPP), and may be found in “IMT-2000 DS-CDMA System”, Association of Radio Industries and Businesses (ARIB) Standard, ARIB STD-T63 Ver. 3.10, published Sep. 26, 2002. The UMTS communication system, as defined by 3GPP, may require compliance of Wideband Code Division Multiple Access (WCDMA), which is related to 3G standard, and Global System for Mobile Communications (GSM) or General Packet Radio Service (GPRS), which is related to 2.5 standard.

During an idle state, a wireless communication device is generally required to monitor a paging channel (e.g., a radio channel assigned to a base station and used to set up calls to mobile devices) in a cellular network in order to detect incoming calls. This procedure consumes current, and may impact strongly on the communication device power consumption. A communication device that supports UMTS (e.g., in universal or dual mode) generally operates in an idle state by performing cell reselection whenever the signal level from a base station serving the cell becomes weak, distorted, noisy, or hindered. Cell reselection may include selecting GSM served cells, WCDMA served cells, or any other wireless communication cell types.

### BRIEF DESCRIPTION OF THE DRAWINGS

Embodiments of the present invention may be better understood and appreciated from the following detailed description taken in conjunction with the appended drawings, it being understood that these drawings are given for illustrative purposes only and are not meant to be limiting, wherein:

FIG. 1 is a simplified block-diagram illustrating an exemplary communication system in accordance with some aspects of exemplary embodiments of the present invention; and

FIG. 2 is a flow chart illustrating an exemplary method of using a selected radio access technology, according to some aspects of exemplary embodiments of the present invention.

It will be appreciated that for simplicity and clarity of illustration, elements shown in the figures have not necessarily been drawn to scale. For example, the dimensions of some of the elements may be exaggerated relative to other elements for clarity. Additionally, like reference numerals may indicate corresponding, analogous, or similar elements.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the description of embodiments of the invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts, functions, or operations leading to a desired result. These may include physical manipulations of physical quantities. Usually, though not necessarily, these quantities may take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing”, “defining”, “calculating”, “determining” or the like, refer to the actions and/or processes of a computer or computing system, or similar electronic computing devices, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses or devices to perform the operations herein. Such devices, as described hereinbelow, may include various types of communication devices that may be used in conjunction with the present invention, including mobile stations, cellular telephones, laptop or notebook computers, Personal Digital Assistants (PDA's), mini computers, pocket computers, wearable computers, paging devices, servers, wire, wireless, or cable modems, or any other communication devices. Such communication devices may be universal mode devices, therefore operating using one or more Radio Access Technologies (RAT). For example, dual mode devices or multi-mode devices may be used, hereinafter referred to as “universal mode” devices, which are adapted to use multiple RATs.

Devices or apparatuses that may be used in conjunction with the present invention may be specially constructed for the desired purposes, or they may comprise a general-purpose computing devices selectively activated or reconfigured by a program stored in such a device. Such a program may be stored on a storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable to store electronic instructions, and capable of being coupled to a system bus for a computing device.

The processes and displays presented herein are not inherently related to any particular computing device or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

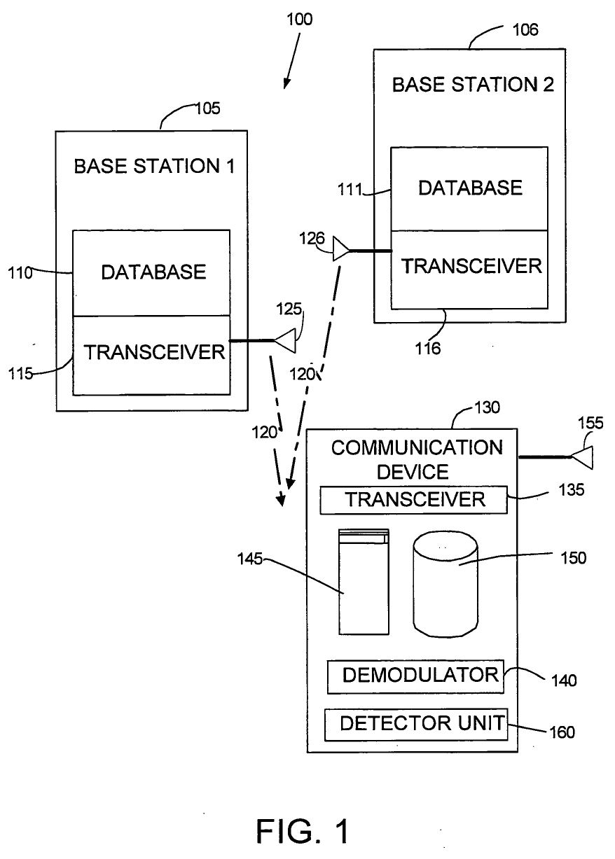

Reference is now made to FIG. 1, which illustrates an exemplary communication system 100 in accordance with an aspect of an embodiment of the present invention. Communications system 100 may include, for example, two Base Stations (BS), e.g., Base Station 105 and Base Station 106, which may transmit data to and receive data from base stations, cellular phones, paging services and other wireless transmission systems within at least one cell that may be served by respective BS 105 and 106. BS 105 and 106 may communicate with a communication device 130 over a communication channel 120. Communications system 100 may include any number of base stations. Communication channel 120 may be, for example, a wireless link of a wireless communications system, part of a wide-area-network (WAN), local-area-network (LAN) or any other network. For example, the system may be a Wireless Local Area Network (WLAN) system or a digital subscriber line (DSL) system, or other type of network. According to aspects of the invention, communication device 130 may be operated at a relatively low energy-consumption rate, by operating primarily or as much as possible using a selected RAT. A selected RAT may be defined as a RAT, for example, which consumes less energy (e.g., current) when the communication device operates in idle state, in comparison to when the communication device operates using an alternative RAT. Primary functioning in the selected RAT may be defined as active functioning in the selected RAT, wherever possible, for example, wherever an adequate signal is able to allow functioning of the communication device using the selected RAT. For example, a selected RAT of a UMTS universal mode communication device may be WCDMA, and therefore when such a communication device operates in idle state using WCDMA technology, less current is consumed in comparison to idle operation when using GSM technology. The various embodiments of the method described below may be performed by, for example, communication device 130 and/or an associated processing platform, for example, a processor and associated instructions as described in detail below, although other suitable devices and/or platforms may perform embodiments of the method.

Base stations 105 and 106, which may be transmission and/or receiving stations in cellular communication system 100. Base station 105 may have a transceiver 115 to generate signals for two or more communication devices 130 and/or other base stations using a particular RAT, e.g., GPRS. Base station 105, for example, may be a serving base station, which may, for example, currently be serving communication data to and/or receiving communication data from communication device 130. Base station 106, for example, may be a neighboring base station, which may have a transceiver 116 to generate signals for two or more communication devices 130 and/or other base stations using a particular RAT, e.g., WCDMA. Base stations 105 and 106 may respectively include databases 110 and 111 to respectively store relevant system data for a cellular communications system. Base stations 105 and 106 may respectively include antennas 125 and 126, such as, for example, internal antennas, dipole antennas, omni-directional antennas, monopole antennas, end fed antennas, circularly polarized antennas, micro-strip antennas, diversity antennas, and the like, to transmit signals to a plurality of communication devices 130 and/or base stations. A serving base station such as 105 or 106 may be a transmission station, for example, that is currently serving signals to and receiving signals from at least one cell or geographical area and may thereby be broadcasting signals to and receiving signals from one or more UMTS based communication devices 130.

Communication device 130, for example, a mobile station using UMTS technology, may include an antenna 155, a transceiver 135, which may include a transmitter, receiver, and any other suitable communication components. Transceiver 135 may enable receiving of incoming signals and transmitting of outgoing signals, via antenna 155, if desired. Antenna 155 may be, for example, an internal antenna, dipole antenna, omni-directional antenna, monopole antenna, end fed antenna, circularly polarized antenna, micro-strip antenna, diversity antenna, and the like. Transceiver 135 may include, for example, a demodulator 140. In some embodiments, transceiver 135 and antenna 155 may be implemented, for example, using separate and/or integrated units. Demodulator 140 may be used to demodulate received signals, and may be implemented in hardware and/or software.

Communication device 130 may include a processor 145, which may include executable code that may enable operation of communication device 130 according to some embodiments of the present invention. Communication device 130 may include a memory unit 150, to store relevant data and instructions etc. Communication device 130 may include a detector unit or mechanism 160, located within one or more of the components of communication device 130, based in hardware, software, or any combination thereof. Detector unit 160 may enable determination or identification of the RAT utilized by a serving base station 105 or 106. Methods of RAT determination and identification are known to those skilled in the art of cellular communications.

Although the scope of embodiments of the present invention is not limited in this respect, processor 145 may include an application specific integrated circuit (ASIC), an application specific standard product (ASSP), a reduced instruction set circuit (RISC), a complex instruction set computer (CISC), a digital signal processor (DSP), a central processing unit (CPU), or any other suitable processor. System data, executable code, and/or instructions, etc., to enable computing unit 145 to perform methods of embodiments of the present invention, may be stored in a memory, disk, or other suitable storage device. Such instructions may be stored, for example, in memory 150, such as a flash card, or other suitable storage medium. Instructions may include computer-readable code, algorithms, definitions, and calculations, etc. Any other suitable computing or communication components may be used. Execution of the instructions may be performed by processor 145, or any other suitable components. The instructions may also be embodied in hardware or any suitable combination of software and/or hardware in accordance with specific implementations of embodiments of the invention.

Design considerations, such as, but not limited to, processor performance, cost and power consumption, may result in a particular processor design, and it should be understood that the design of processor 145 is merely an example, and that embodiments of the invention are applicable to other processor designs as well.

Although the scope of embodiments of the present invention is not limited in this respect, communication system 100 shown in FIG. 1 may be part of a cellular communication system, with base stations 105 and 106 being transmission stations, and communication device 130 being a mobile station, a pager communication device, a personal digital assistant (PDA) and/or any other suitable communications device. In the case of a cellular wireless communication system, according to some embodiments of the present invention, communication system 100 shown in FIG. 1 may be a 3rd Generation Partnership Project (3GPP), such as, for example, Frequency Domain Duplexing (FDD), Wideband Code Division Multiple Access (WCDMA) cellular system and the like.

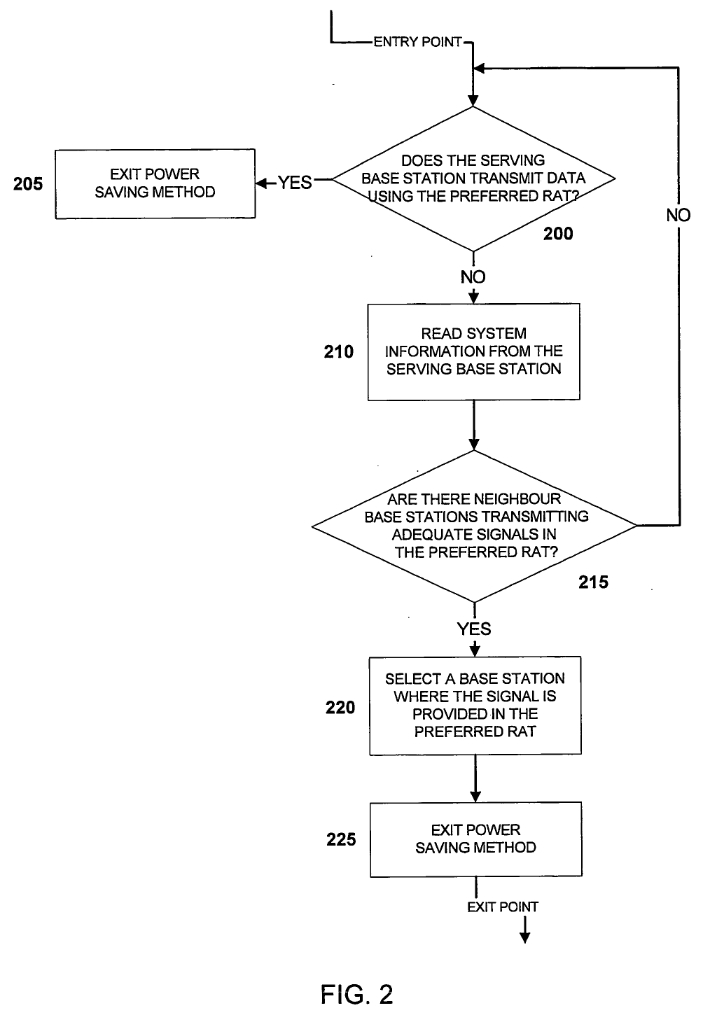

Reference is now made to FIG. 2, which illustrates an exemplary method of power saving in a mobile station, for example, a UMTS universal mode communication device according to some exemplary embodiments of the present invention. In block 200, communication device 130 periodically queries a serving base station, for example BS 105, which may be serving the cell in which the communication device is located, to determine whether the serving base station 105 transmits signals using the communication device's selected predefined Radio Access Technology (RAT). In some embodiments for example, the RAT may be selected from GSM/GPRS or WCDMA etc. In other embodiments the RAT may be selected from PDC or WCDMA/CDMA etc. For example, a criterion for selecting may include selecting a RAT that enables relative power saving in the communication device during idle operation. For example, if communication device 130 is a dual mode communication device, supporting both WCDMA and GSM/GPRS RATs, communication device 130 may have a selected predefined RAT, such that monitoring a paging channel from, for example, base station 105 using the selected RAT, for example, GSM, may require lower energy consumption as compared to doing such monitoring using another RAT, for example, WCDMA. Such operation of communication device 130 using a selected predetermined RAT may enable operating in a power saving mode. Communication device 130 may initiate such a query periodically and/or randomly and/or any other desired method.

In block 205, if the serving base station 105 transmits signals using the selected RAT, the power saving mode may be exited, and communication device 130 may continue normal operation using the communication device's selected RAT.

In block 210, if the serving base station 105 does not transmit signals using the selected RAT, communication device 130 may initiate reading of system information from the serving base station 105. Such system information may include data relating to the RAT's of neighboring base stations, for example, BS 106. Neighboring base station 106 may be any base station that is able to provide signals to communication device 130. Such reading of system information may be initiated irrespective of the signal strength being broadcast by the serving base station 105. For example, an operation to read system information may be initiated when the signal being received by communication device 130 meets a predetermined criterion of adequacy or inadequacy, for example, when the signal is found to be sufficiently strong or weak in comparison to a predetermined value or using any other suitable value or criteria. For example, the determination of a GSM cell signal adequacy may be based on Received Signal Strength Indication (RSSI) measurements over a GSM Broadcast Control Channel (BCCH) carrier. An example of a determination of WCDMA cell signal adequacy may be based, for example, on a Received Signal Code Power (RSCP), a ratio of received pilot energy (Ec) to total received energy, or total power spectral density (Io) (Ec/Io) over a Common Pilot Channel (CPICH), or any combination known in the art. Other methods may be used for determining signal adequacy.

In block 215, communication device 130 may determine whether there are one or more neighboring base stations that are transmitting adequate signals using the selected RAT. If there are no neighboring base stations transmitting adequate signals using the selected RAT, communication device 130 may exit the power saving mode, and return to the entry point before block 200. An adequate signal may be defined as an incoming signal of sufficient strength to enable communication device 130 in an idle state to monitor a paging path from a base station of a cell.

In block 220, if there is at least one neighboring base station 106 transmitting adequate signals using the selected RAT, communication device 130 may select a neighboring base station, e.g., BS 106, to be its new serving base station where such adequate signals are transmitted using the selected RAT. In block 225, the power saving mode may be exited.

Other functions, operations, or combinations of operations may be implemented.

While certain features of embodiments of the present invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the present invention.

1. A method comprising;
during an idle state of operation of a universal mode communication device operating in a Universal Mobile Telecommunications System, selecting a base station to serve the communication device based on a selected Radio Access Technology of the communication device.

2. The method of claim 1 comprising:
determining whether a serving base station transmits signals using said selected Radio Access Technology.

3. The method of claim 1, comprising determining whether a neighboring base station transmits substantially adequate signals using said selected Radio Access Technology.

4. The method of claim 3, wherein determining whether a neighboring base station transmits substantially adequate signals using said selected Radio Access Technology comprises reading system information transmitted from a serving base station.

5. The method of claim 1, comprising selecting a neighboring base station that transmits adequate signals using said selected Radio Access Technology if a serving base station does not transmit signals using said selected Radio Access Technology.

6. The method of claim 5, comprising initiating said selecting of said neighboring base station when said serving base station transmits signals that are substantially adequate.

7. The method of claim 1, comprising monitoring a paging channel from two or more said base stations primarily using said selected Radio Access Technology.

8. The method of claim 1, wherein said selected radio access technology is defined according to energy usage of said communication device during said idle state operation.

9. An apparatus comprising:
a processor to select a base station to serve a communication device, during an idle state of operation, said selection of said base station being based on a selected Radio Access Technology of the apparatus, the apparatus being a universal mode communication device operating in a Universal Mobile Telecommunications System.

10. The apparatus of claim 9, wherein said processor is adapted to enable said communication device to monitor a paging channel from a base station primarily using said selected Radio Access Technology.

11. The apparatus of claim 9, wherein said processor is adapted to select a neighboring base station if the signal being transmitted from said neighboring base station to said communication device is adequate, and the signal being transmitted from a serving base station uses a non-selected Radio Access Technology.

12. The apparatus of claim 9, comprising a memory unit associated with said processor.

13. The apparatus of claim 9, comprising at least one of an application specific integrated circuit (ASIC), an application specific standard product (ASSP), a reduced instruction set circuit (RISC), a complex instruction set computer (CISC), a digital signal processor (DSP), and a central processing unit (CPU).

14. A communication device, comprising:
a processor to select a base station to serve the communication device, during an idle state of operation, said selection of said base station being based on a selected Radio Access Technology of the communication device, the communication device being a universal mode communication device operating in a Universal Mobile Telecommunications System; and
an antenna to receive and transmit signals in said Universal Mobile Telecommunications System.

15. The communication device of claim 14, wherein said processor is adapted to enable the communication device to monitor a paging channel from a base station primarily using said selected Radio Access Technology.

16. The communication device of claim 14, wherein said processor is adapted to select a neighboring base station if the signal being transmitted from said neighboring base station to the communication device is adequate, and the signal being transmitted from a serving base station uses a non-selected Radio Access Technology.

17. The communication device of claim 14, comprising a memory unit associated with said processor.

18. The communication device of claim 14, comprising at least one of an application specific integrated circuit (ASIC), an application specific standard product (ASSP), a reduced instruction set circuit (RISC), a complex instruction set computer (CISC), a digital signal processor (DSP), and a central processing unit (CPU).

19. A Universal Mobile Telecommunications System, comprising:
two or more base stations to transmit signals; and
a communication device comprising a processor, to select, during an idle state of operation, at least one of two or more of said base stations to serve said signals to said communication device, based on a selected Radio Access Technology of said communication device.

20. The system of claim 19, wherein said base station selected by said processor is a base station neighboring a serving base station of said communication device, wherein said neighboring base station transmits an adequate signal to said communication device using said selected Radio Access Technology.

21. The system of claim 19, wherein said communication device includes a memory unit associated with said processor.

22. An article comprising a storage medium having stored thereon instructions that, when executed by a processing platform, result in:
selecting during an idle mode of operation of a universal mode communication device operating in a Universal Mobile Telecommunications System, a base station to serve said communication device, based on a selected Radio Access Technology of said communication device.

23. The article of claim 22, comprising determining said selected Radio Access Technology according to communication device energy usage during idle state operation.

24. The article of claim 22, wherein the instructions result in determining whether a neighboring base station transmits substantially adequate signals using said selected Radio Access Technology.

25. The article of claim 22, wherein the instructions result in selecting a neighboring base station that transmits an adequate signal using said selected Radio Access Technology, if a serving base station does not transmit signals using said selected Radio Access Technology.

26. The article of claim 22, wherein the instructions further result in initiating said selecting of said base station when signals in a served cell are substantially adequate.

27. The article of claim 22, wherein the instructions result in monitoring a paging channel from said base station primarily using said selected Radio Access Technology.
